(19) United States
(12) Patent Application Publication
(10) Pub. No.: US 2011/0233479 A1
(43) Pub. Date: Sep. 29, 2011

(54) Process for preparing an elastomeric composite material

(75) Inventors: Alexander Korzhenko, Pau (FR); Amelie Merceron, Aussevielle (FR)

(73) Assignee: Arkema France, Colombes (FR)

(21) Appl. No.: 13/053,787

(22) Filed: Mar. 22, 2011

(30) Foreign Application Priority Data
Mar. 25, 2010 (FR) 10.52146

(51) Int. Cl. H01B 1/24; B82Y 30/00

(52) U.S. Cl. 252/511; 977/742

(57) ABSTRACT

The present invention relates to a process for preparing a composite material containing an elastomeric matrix and nanotubes, in particular carbon nanotubes, and also to the composite material thus obtained and to the use thereof for the manufacture of composite products.

It also relates to the use, for conferring at least one electrical and/or mechanical and/or thermal property on an elastomeric matrix, of a masterbatch that can be obtained by kneading, in a compounding device, and then extruding, a polymer composition containing at least one oil and nanotubes, in particular carbon nanotubes, and optionally a tackifying resin.

The present invention relates to a process for preparing a composite material containing an elastomeric resin base and nanotubes, in particular carbon nanotubes, and also to the composite material thus obtained and to the use thereof for manufacturing composite products.

Elastomers are polymers endowed with rubbery elasticity properties, which find application in various fields, including the manufacture of motor vehicle components such as tires, seals or tubes, and the pharmaceutical, electrical, transportation or construction industry, for example. In some of these applications, it may be advantageous to give them electrical conduction properties and/or to improve their mechanical properties. To do this, it is possible to incorporate into them conductive fillers such as carbon nanotubes (or CNTs).

Thus, document WO 2007/035442 describes a process for incorporating from 0.1% to 30% by weight, and preferably from 0.1% to 1% by weight of CNTs into a liquid or solid silicone resin base, which consists in dispersing said CNTs in the resin base by means of conventional mixing devices, roll mills or ultrasonication. The silicone resin is then cured (crosslinked) so as to obtain a silicone elastomer.

The technique proposed in said document is not, however, readily transposable to other elastomeric resin bases, and in particular to elastomers of olefinic nature, such as natural rubber, polyisoprene or polybutadiene. This is because the low apparent density of CNTs requires the application of strong mechanical energy in order to disperse them in these resins, which results in strong heating capable of causing degradation of the elastomeric matrix.

In addition, the handling of CNTs in pulverulent form is not convenient for the elastomeric product formulator. The differences in sizes, in form and in physical properties of CNTs mean, moreover, that the toxicological properties of CNT powders are not yet entirely known. It would therefore be preferable to be able to work with CNTs in an agglomerated solid form of macroscopic size, for example in the form of granules, which are easier to handle and to transport than a powder.

There is thus still a need for a means for simply and uniformly dispersing nanotubes in an elastomeric resin base, without substantially degrading said resin, using the devices conventionally employed in the elastomer industry.

In order to meet these needs, precomposites based on CNTs and plasticizers, prepared in particular in a cone mixer and intended to be diluted in an elastomeric matrix, have already been proposed (FR 2 916 364). Nevertheless, the choice of polymer binder/plasticizer systems is very limited for olefin elastomers in terms of compatibility.

However, the applicant has discovered that the abovementioned needs can, as a variation, be met by using a masterbatch based on oil, in particular mineral oil, for preparing elastomeric composite materials.

A subject of the present invention is thus a process for preparing an elastomeric composite material, comprising the successive steps:

(a) of introducing at least one oil and nanotubes into a compounding device and then kneading said at least one oil and said nanotubes in said device, so as to obtain a masterbatch,
(b) of extruding said masterbatch,
(c) of diluting the masterbatch in an elastomeric matrix.

It is clearly understood that this process can comprise other steps that are preliminary, intermediate or subsequent to those above, as long as they are not detrimental to the dispersion of the nanotubes or to the integrity of the elastomeric matrix. Thus, this process can, for example, include an intermediate step (b′) of forming the masterbatch in the form of granules, a fiber or a strip, which can then be cut to the desired size. In addition, this process generally includes an additional step (c′) of vulcanization.

A subject of the invention is also the elastomeric composite material that can be obtained according to the process above.

A subject of the invention is also the uses of this composite material.

Finally, a subject of the invention is the use, for conferring at least one electrical and/or mechanical and/or thermal property on an elastomeric matrix, of a masterbatch that can be obtained by kneading, in a compounding device, and then extruding, a polymer composition containing at least one oil and nanotubes.

The process according to the present invention will presently be described in greater detail.

This process comprises a first step of introducing at least one oil and nanotubes into a compounding device.

For the purpose of the present invention, the term “oil” is intended to mean a medium which is liquid at ambient temperature (25° C.) and atmospheric pressure, and which is water-immiscible (formation of 2 phases visible to the naked eye at ambient temperature and atmospheric pressure). This liquid medium has in particular a solubility in water, measured according to OECD method TG 105, of less than or equal to 1 mg/l. This liquid medium may be more or less viscous; in particular, it has a dynamic viscosity at ambient temperature of between 0.1 cP and 500 cP, and preferably between 0.3 and 300 cP. As a variation, it has a dynamic viscosity at ambient temperature of between 500 cP and 35000 cP.

According to the invention, one or more oils that are generally miscible with one another can be used. These oils may be polar or, better still, apolar.

Examples of oils suitable for use in the present invention comprise:
plant oils with a high content (for example at least 50% by weight) of triglycerides consisting of fatty acid esters of glycerol, the fatty acids of which can have varied chain lengths, it being possible for said chains to be linear or branched, saturated or unsaturated; these oils are in particular wheatgerm oil, corn oil, sunflower oil, linseed oil, shea oil, castor oil, sweet almond oil, macadamia oil, apricot oil, soy oil, cottonseed oil, alfalfa oil, poppyseed oil, pumpkin oil, sesame oil, marrow oil, avocado oil, hazelnut oil, grapeseed or blackcurrant seed oil, evening primrose oil, millet oil, barley oil, quinoa oil, olive oil, rye oil, safflower oil, candlenut oil, passion flower oil, musk rose oil; or else caprylic/capric acid triglycerides;
synthetic oils of formula R1COOR2 in which R1 represents an aryl group or the residue of a linear or branched, higher fatty acid containing from 7 to 30 carbon atoms, and R2 represents a branched or unbranched, optionally hydroxylated, hydrocarbon-based chain containing from 3 to 30 carbon atoms, for instance PurCellin® oil (cetostearyl octanoate), isononyl isononanoate, C12 to C15 alkyl benzoate, isostearyl benzoate, isopropyl myristate, octanoates, decanoates or ricinoleates of alcohols or of polyalcohols;
synthetic ethers, such as petroleum ether;
linear or branched, saturated or unsaturated C6 to C26 fatty alcohols, in particular branched or unsaturated fatty alcohols such as oleyl alcohol or octyldodecanol;
silicone oils, such as polydimethylsiloxanes which are liquid at ambient temperature; polydimethylsiloxanes comprising alkyl or alkoxy groups that are pendant and/or at the end of a silicone chain, said groups having from 2 to 24 carbon atoms; phenyl silicones, for instance phenyl trimethicones, phenyl dimethicones, phenyltrimethylsiloxydiphenylsiloxanes, diphenyl dimethicones, diphenylmethyldiphenyltrisiloxanes;
oils of mineral origin, for instance linear or branched hydrocarbons, such as liquid paraffins and oils of paraffin derivatives, petroleum jelly, polydecenes, hydrogenated polyisobutene (in particular Parleam®), squalane;
polymers containing linear or branched hydrocarbon-based monomers, for example C5 or C9, and/or aromatic hydrocarbon-based monomers (for example, the product Wingtack®10);
cyclic hydrocarbons, for instance (alkyl)cycloalkanes and (alkyl)cycloalkenes, the alkyl chain of which is linear or branched, and saturated or unsaturated, having from 1 to 30 carbon atoms, such as cyclohexane, dioctylcyclohexane, 2,4-dimethyl-3-cyclohexene and dipentene;
aromatic hydrocarbons, for instance benzene, toluene, p-cymene, naphthalene or anthracene;
fluoro oils, for instance C8 to C24 perfluoroalkanes;
fluorosilicone oils;

and mixtures thereof.

Use is preferably made of a mineral oil, for instance a liquid paraffin, such as the product sold by Total under the tradename EDC® 99-DW or EDC® 95-11; this oil has a viscosity of 3.5 cPs.

The amount of oil included in the masterbatch prepared in the first step of the process according to the invention can represent from 20% to 95% by weight, preferably from 50% to 90% by weight, and better still from 70% to 85% by weight, relative to the weight of the masterbatch.

The nanotubes used in the process according to the invention may be carbon nanotubes (hereinafter CNTs) or nanotubes based on boron, phosphorus or nitrogen, or else nanotubes containing several of these elements or at least one of these elements in combination with carbon. They are advantageously carbon nanotubes. These nanotubes have particular crystal structures, of tubular, hollow and closed shape, composed of atoms regularly arranged in pentagons, hexagons and/or heptagons, obtained from carbon. CNTs generally consist of one or more rolled-up graphene leaflets. Single-wall nanotubes (SWNTs) and multi-wall nanotubes (MWNTs) are thus distinguished. Double-wall nanotubes may in particular be prepared as described by Flahaut et al. in Chem. Com. (2003), 1442. Multi-wall nanotubes may be prepared, for their part, as described in document WO 03/02456.

The nanotubes used according to the invention usually have a mean diameter ranging from 0.1 to 200 nm, preferably from 0.1 to 100 nm, more preferably from 0.4 to 50 nm, and better still from 5 to 30 nm, and advantageously a length of more than 0.1 μm and advantageously from 0.1 to 20 μm, for example approximately 6 μm. Their length/diameter ratio is advantageously greater than 10 and usually greater than 100. These nanotubes therefore in particular comprise “VGCF” nanotubes (carbon fibers obtained by chemical vapor deposition, or vapor-grown carbon fibers). Their specific surface area is, for example, between 100 and 300 m²/g, preferably between 200 and 250 m²/g, and their apparent density may in particular be between 0.01 and 0.5 g/cm³ and more preferably between 0.07 and 0.2 g/cm³. The multi-wall carbon nanotubes may comprise, for example, from 5 to 15 leaflets and more preferably from 7 to 10 leaflets.

An example of crude carbon nanotubes is in particular commercially available from the company Arkema under the tradename Graphistrength® C100.

The nanotubes may be purified and/or treated (in particular oxidized) and/or ground before being used in the process according to the invention. They may also be functionalized by means of chemical methods in solution, for instance amination or reaction with coupling agents.

Grinding of the nanotubes may in particular be carried out with or without heating and may be performed according to the known techniques implemented in devices such as ball mills, hammer mills, attrition mills, knife mills, gas-jet mills or any other grinding system capable of reducing the size of the entangled network of nanotubes. It is preferred for this grinding step to be carried out according to a gas-jet grinding technique and in particular in an air-jet mill.

Purification of the nanotubes can be carried out by washing with a solution of sulfuric acid, or of another acid, so as to free them of any residual mineral and metallic impurities originating from their preparation process. The weight ratio of the nanotubes to sulfuric acid may in particular be between 1:2 and 1:3. The purification operation may, moreover, be carried out at a temperature ranging from 90 to 120° C., for example for a period of 5 to 10 hours. This operation may advantageously be followed by steps of rinsing with water and drying of the purified nanotubes. Another route for purifying the nanotubes, which is intended in particular for removing the iron and/or magnesium that they contain, consists in subjecting them to a heat treatment above 1000° C.

Oxidation of the nanotubes is advantageously carried out by placing them in contact with a solution of sodium hypochlorite containing from 0.5% to 15% by weight of NaOCl and preferably from 1% to 10% by weight of NaOCl, for example in a weight ratio of the nanotubes to sodium hypochlorite ranging from 1:0.1 to 1:1. The oxidation is advantageously carried out at a temperature below 60° C., and preferably at ambient temperature, for a period ranging from a few minutes to 24 hours. This oxidation operation may advantageously be followed by steps of filtration and/or centrifugation, washing and drying of the oxidized nanotubes.

However, it is preferred for the nanotubes to be used in the process according to the invention in crude form.

Moreover, it is preferred, according to the invention, to use nanotubes obtained from starting materials of renewable origin, in particular of plant origin, as described in document FR 2 914 634.

The amount of nanotubes included in the masterbatch prepared in the first step of the process according to the invention may represent from 5% to 80% by weight, preferably from 10% to 50% by weight, and better still from 15% to 30% by weight, relative to the weight of the masterbatch.

According to a first embodiment, it is preferred, moreover, for the masterbatch to contain only oil and nanotubes.

According to a second embodiment, it is preferred for the masterbatch comprising the oil and the nanotubes to also comprise one or more additives. The additive(s) may be waxy or solid at atmospheric pressure and ambient temperature. The glass transition temperature Tg may be between 25° C. and 150° C., preferably between 35° C. and 70° C. In particular, it is preferred for the masterbatch to comprise at least one tackifying resin. The term “tackifying resin” is intended to mean, in the field of industrial adhesive bonding, a thermoplastic resin which confers, on an adhesive, the ability to attach on contact with a support. Such resins are, for example, aromatic and/or aliphatic, preferably C4 to C9, hydrocarbon-based resins. The number-average molecular weight of the resins may be between 100 and 50000 g/mol, preferably between 400 and 2000 g/mol. Examples of resins that can be used as additive in the masterbatch are the Norsolene® and Wingtack® resins from the company Cray Valley. The hydrocarbon resins may be functionalized with, for example, hydroxyl, carboxyl, anhydride and/or amine functions.

According to this second embodiment, the amount of additive(s), in particular of tackifying resin, included in the masterbatch prepared in the first step of the process according to the invention may represent from 1% to 80% by weight, preferably from 5% to 60% by weight, and better still from 20% to 50% by weight, relative to the weight of the masterbatch.

The amount of oil included in the masterbatch prepared in the first step of the process according to the invention may represent from 1% to 80% by weight, preferably from 5% to 50% by weight, and better still from 10% to 40% by weight, relative to the weight of the masterbatch.

According to the present invention, the oil and the nanotubes are introduced into a compounding device.

In the present description, the term “compounding device” is intended to mean an apparatus conventionally used in the plastics industry for the melt blending of thermoplastic polymers and additives in order to produce composites. In this apparatus, the polymer composition and the additives are mixed together by means of a high-shear device, for example a co-rotating or counter-rotating twin-screw extruder or a co-kneader. The melt generally leaves the apparatus in an agglomerated solid physical form, for example in the form of granules, or in the form of rods, a strip or a film.

Examples of co-kneaders that may be used according to the invention are the Buss® MDK 46 co-kneaders and those of the Buss® MKS or MX series, sold by the company Buss AG, which all consist of a screwshaft provided with wings, arranged in a heating sheath optionally consisting of several parts and the inner wall of which is provided with kneading teeth designed to engage with the wings so as to produce shear of the kneaded material. The shaft is rotated, and provided with an oscillating movement in the axial direction, via a motor. These co-kneaders may be equipped with a system for manufacturing granules, adapted, for example, to their outlet orifice, which may consist of an extrusion screw or a pump.

The co-kneaders that can be used according to the invention preferably have an L/D screw ratio ranging from 7 to 22, for example from 10 to 20, whereas co-rotating extruders advantageously have an L/D ratio ranging from 15 to 56, for example from 20 to 50.

The introduction of the oil and the nanotubes into the compounding device may be carried out in various ways.

Thus, in a first embodiment of the invention, the nanotubes may be introduced into a feed hopper of the compounding device, whereas the oil is introduced via a separate introduction member. The additives, in particular the tackifying resin(s), may be introduced into the same feed hopper or into said separate introduction member.

In a second embodiment of the invention, the oil and the nanotubes (and the optional additives such as the tackifying resin(s)) may be introduced successively, in any order, into the same feed zone of the mixer. As a variation, the abovementioned materials may be introduced simultaneously, into the same feed zone (for example the same hopper), after having been homogenized in a suitable container in order to form a premix.

In the latter variation, the premix may, for example, be obtained according to a process involving:

1—bringing the oil into contact with the powdered nanotubes, for example by dispersion of the nanotubes in the oil, by dropwise introduction of the oil into the nanotube powder or by spraying the oil onto the nanotube powder using a spraying device, and

2—drying the product obtained.

The first step of this process can be carried out in conventional synthesis reactors, blade mixers, fluidized-bed reactors or mixing equipment of the Brabender, Z-blade mixer or extruder type. It is generally preferable to use a cone mixer, for example of the Vrieco-Nauta type from Hosokawa, comprising a rotary screw rotating along the wall of a conical vessel. In this first step, the products are brought into contact preferably without applying mechanical shear forces.

In the case where a masterbatch comprising an additive such as a tackifying resin is prepared, it may be envisioned to add this additive during this first phase of the process. If this additive is in solid form at ambient temperature and at atmospheric pressure, the temperature of the mixing step may be adjusted so as to ensure efficient wetting of all the compounds.

After introduction into the compounding device, the nanotubes premixed with the oil are kneaded together, for example at ambient temperature, in particular between 20° C. and 45° C., or at a temperature between 80° C. and 110° C. (in particular when a solid tackifying resin is present). The kneading of the mixture of nanotubes and oil in a compounding device make it possible to obtain a masterbatch which is homogeneous through the application of mechanical shear forces and, when a co-kneader is used, through placing the products under pressure in the zones of the co-kneader which precede the restriction rings. The kneading is followed by extrusion of said masterbatch, in particular in solid form at ambient temperature.

Thus, according to one embodiment, step (a) of the process according to the invention comprises the substeps consisting in:

1—bringing the oil into contact with the nanotubes without applying mechanical shear forces,

2—introducing the premix of nanotubes and oil into a compounding device and kneading said premix in said compounding device by applying mechanical shear forces, so as to obtain a masterbatch.

This preferred embodiment of the invention is nondestructive with respect to the nanotubes in the sense that the average length of the nanotubes in the final material compared with that of the nanotubes introduced is not affected by the applicative transformation undergone.

In any event, the applicant has demonstrated that the process according to the invention makes it possible to obtain masterbatches which can contain a high content of nanotubes, such as CNTs, and which can be easily handled, insofar as they are in agglomerated solid form, in particular in the form of granules, at the end of step (b) of the process according to the invention. These masterbatches may thus be transported in sacks or barrels from the production center to the transformation center where they are diluted in an elastomeric matrix, in accordance with step (c) of the process according to the invention.

This dilution step can be carried out by means of any device conventionally used in the elastomer industry, in particular using internal mixers, or roll (two-roll or three-roll) mixers or mills. The amount of masterbatch introduced into the elastomeric matrix depends on the level of nanotubes that it is desired to add to this matrix in order to obtain the desired mechanical and/or electrical and/or thermal properties. The final composite material may thus contain from 0.5% to 5% by weight of nanotubes, for example.

This elastomeric matrix comprises an elastomeric resin base, and also, optionally, various additives, such as conductive fillers other than the nanotubes (in particular carbon black and/or mineral fillers), lubricants, pigments, stabilizers, fillers or reinforcing agents, antistatic agents, fungicides, flame retardants, solvents, and mixtures thereof.

In the present description, the term “elastomeric resin base” is intended to mean an organic or silicone polymer which forms, after vulcanization, an elastomer capable of withstanding large deformations virtually reversibly, i.e. an elastomer that can be subjected to a uniaxial deformation, advantageously of at least twice its original length at ambient temperature (23° C.), for five minutes, and then recover, once the stress has been removed, its initial dimension, with a remanent deformation of less than 10% of its initial dimension.

From the structural point of view, elastomers generally consist of polymer chains connected together to form a three-dimensional network. More specifically, a distinction is sometimes made between thermoplastic elastomers, in which the polymer chains are connected together via physical bonds, such as hydrogen bonds or dipole-dipole bonds, and thermosetting elastomers, in which these chains are connected via covalent bonds, which constitute points of chemical crosslinking. These crosslinking points are formed by means of vulcanization processes using a vulcanizing agent that may be chosen, for example, according to the nature of the elastomer, from sulfur-based vulcanizing agents, in the presence of dithiocarbamate metal salts; zinc oxides combined with stearic acid; optionally halogenated difunctional phenol-formaldehyde resins, in the presence of tin chloride or zinc chloride; peroxides; amines; hydrosilanes in the presence of platinum; etc.

The present invention relates more particularly to the elastomeric resin bases containing, or consisting of, thermosetting elastomers optionally as a mixture with non-reactive, i.e. non-vulcanizable, elastomers (such as hydrogenated rubbers).

The elastomeric resin bases that may be used according to the invention may in particular comprise, or even consist of, one or more polymers chosen from: fluorocarbon or fluorosilicone elastomers; butadiene homopolymers and copolymers, optionally functionalized with unsaturated monomers such as maleic anhydride, (meth)acrylic acid, acrylonitrile (NBR) and/or styrene (SBR); neoprene (or polychloroprene); polyisoprene; copolymers of isoprene with styrene, butadiene, acrylonitrile and/or methyl methacrylate; copolymers based on propylene and/or ethylene and in particular terpolymers based on ethylene, propylene and dienes (EPDM), and also copolymers of these olefins with an alkyl (meth)acrylate or vinyl acetate; halogenated butyl rubbers; silicone elastomers such as poly(dimethylsiloxane)s with vinyl end groups; polyurethanes; polyesters; acrylic polymers such as poly(butyl acrylate) bearing carboxylic acid or epoxy functions; and also modified or functionalized derivatives thereof and mixtures thereof, without this list being limiting.

According to the invention, an olefin homopolymer or copolymer is preferably used.

The composite material obtained after dilution of the masterbatch in the elastomeric matrix can be formed according to any appropriate technique, in particular by injection-molding, extrusion, compression or molding, followed by a vulcanization treatment. A vulcanizing agent may have been added to the masterbatch during the compounding step (in the case where its activation temperature is higher than the compounding temperature). However, it is preferable for it to be added to the elastomeric matrix before or during its forming, so as to have more leeway in adjusting the properties of the composite material.

The composite material thus obtained may in particular be used for the manufacture of various composite products, such as bodywork or leakproofing seals, tires, sound-insulating plates, static charge dissipators, an inner conductive layer for high-voltage and medium-voltage cables, or anti-vibration systems such as motor vehicle shock absorbers, or alternatively in the manufacture of structural elements of bullet-proof vests, without this list being limiting.

The invention will be understood more clearly in the light of the nonlimiting and purely illustrative examples that follow.

### EXAMPLES

### Example 1

### Manufacture of a Masterbatch

Carbon nanotubes (Graphistrength® C100 from Arkema) were introduced into the feed well of zone 1 of a Buss® MDK 46 co-kneader (L/D=11). A weight amount of mineral oil (EDC® 99 DW from Total) representing four times that of the CNTs was introduced into the injection pump of the first zone of the apparatus, before the first restriction ring. The kneading was carried out at ambient temperature. At the outlet of the co-kneader, solid rods were obtained, which were cut up so as to obtain a masterbatch in the form of solid granules containing 20% by weight of CNT and 80% by weight of oil.

### Example 2

### Manufacture of a Composite Material

The masterbatch obtained in example 1 was incorporated, at ambient temperature, into polyisoprene using a roll mixer. The amount of masterbatch added was determined in such a way as to introduce 5 parts by weight of CNT per 100 parts by weight of elastomeric matrix.

It was noted that the incorporation of the masterbatch was easy and produced a homogeneous composite material that did not stick to the rolls. A vulcanization system was then added, consisting of 5 parts by weight of zinc oxide; 2 parts by weight of stearic acid; 1.4 parts by weight of sulfur and 0.8 part by weight of 2-bisbenzothiazole-2,2′-disulfide (MBTS), for 100 parts by weight of resin. A vulcanization treatment was then carried out in a tarragon press at 170° C. for 20 minutes (150 bar). An elastomeric composite material was thus obtained.

### Example 3

### Evaluation of the Electrical and Mechanical Properties of the Composite Material

The volume electrical resistivity of the composite material 2A, manufactured as described in example 2, was measured according to standard ISO 1853. Tensile tests were, moreover, carried out on the test pieces H2 with the cell at 1 kN at a speed of 50 mm/min (according to standard ISO 37). After the test pieces had been cut up, their heel was tested for Shore A hardness according to standard ASTM D2240. Comparative tests were carried out using:

as a control, polyisoprene (sample 2B) devoid of conductive fillers,

a composite material 2C manufactured in a manner similar to example 2, starting from a masterbatch prepared as described in example 1, except that the CNTs were replaced with Ensaco® 250G carbon black from Timcal,

a composite material 2A′ manufactured in a manner similar to example 2, but including only 2 parts by weight of CNT per 100 parts by weight of resin (i.e. 2 phr).

The results of these tests are collated in table 1 below.

TABLE 1
Characterization of the elastomeric composite material

| | Sample | | | |
|---|---|---|---|---|
| | 2B | 2C | 2A′ | 2A |
| Hardness (Shore A units) | 32 | 32 | 32 | 39 |
| Elongation (%) | 780 | 725 | 750 | 575 |
| Tensile strength (MPa) | 3.4 | 2.2 | 2.2 | 2.5 |
| Modulus at 100% (MPa) | 0.35 | 0.34 | 0.31 | 0.5 |
| Surface resistivity SRM 110: cured | >10¹² | 10¹² | 10⁹ | 10³ |
| (ohm) | | | | |
| Volume resistivity Ag lacquer | >10⁷ | >10⁷ | >10⁷ | 10⁴ |
| (ohm · cm) | | | | |

It emerges from these tests that the introduction of 5 phr (i.e. 3.7% by weight) of CNTs into the composite material does not substantially increase the hardness of the material, compared with the composite material 2A′ containing only 2 phr of said CNTs, since the material 2A remains extremely flexible, while at the same time reducing to a large extent the resistivity of the material as far as making it conductive, and greatly increasing its modulus at 100%.

By comparison, the material 2C containing the same amount of carbon black is not conductive and its modulus at 100% is no higher than that of the control 2B.

### Example 4

### Manufacture of a Masterbatch with a Solid Tackifying Resin

Carbon nanotubes (Graphistrength® C100 from Arkema) and a solid hydrocarbon resin (Norsolene® M1080 produced by the company Cray Valley) were introduced into the feed well of zone 1 of a Buss® MDK 46 co-kneader (L/D=11). A mineral oil (EDC® 99 DW from Total) was introduced into the injection pump of the first zone of the apparatus, before the first restriction ring. The kneading was carried out at a temperature of 100° C. At the outlet of the co-kneader, solid rods were obtained which were cut up so as to obtain a masterbatch in the form of solid granules containing 30% of carbon nanotubes, 40% of mineral oil and 30% of hydrocarbon resin, relative to the total weight of the masterbatch.

According to the method described in this example, it is possible to produce other masterbatches containing up to 50% of carbon nanotubes using various hydrocarbon resins. Said resin is preferably judiciously chosen according to the elastomeric matrix into which the masterbatch is introduced.

By way of example:

| | |
|---|---|
| Elastomer matrix | Hydrocarbon resin recommended |
| | in the masterbatch |
| Butyl rubber | Wingtack ® STS, |
| Natural rubber | Norsolene ® M1080 |
| Polyisoprene | |
| Chlorobutyl rubber | Wingtack ® 86 |
| EPDM | Wingtack ® ET, STS 86 and 95 |
| EVA | Wingtack ® 86 |
| Polybutadiene | Wingtack ® 86 |
| SBR, SBS, SIR | Wingtack ® 86 |

The electrical and mechanical properties of a composite material based on polyisoprene, grade SKI 3S containing 3 phr of CNTs introduced using the masterbatch of example 4, were determined under the same conditions as those indicated in example 3.

TABLE 2

| | Control | With 3 phr CNT |
|---|---|---|
| Hardness (Shore A | 34 | 49 |
| units) | | |
| Elongation (%) | 700 | 610 |
| Tensile strength | 3.3 | 7.0 |
| (MPa) | | |
| Modulus at 100% | 0.42 | 0.77 |
| (MPa) | | |
| Surface resistivity | >10¹² | 10⁵ |
| SRM 110 (ohm) | | |
| Volume resistivity | >10¹² | 4 × 106 |
| (ohm · cm) | | |

### Example 5

### Manufacture of a Masterbatch

Carbon nanotubes (Graphistrength® 0100 from Arkema) were introduced into the feed well of zone 1 of a Buss® MDK 46 co-kneader (L/D=11). A liquid hydrocarbon-based polymer, Wingtack®10 produced by the company Cray Valley, and a mineral oil (EDC® 99 DW from Total) were introduced via two injection pumps into the first zone of the apparatus, before the first restriction ring. The kneading was carried out at a temperature of 50° C. At the outlet of the co-kneader, solid rods were obtained which were cut up so as to obtain a masterbatch in the form of solid granules containing 35% of carbon nanotubes, 15% of mineral oil and 50% of liquid hydrocarbon-based polymer, relative to the total weight of the masterbatch.

According to the method described in this example, it is possible to produce other masterbatches containing up to 50% of carbon nanotubes using various liquid hydrocarbon-based polymers, alone or as a mixture with a mineral oil.

The masterbatches described in examples 4 and 5 are used in the manufacture of elastomeric composite materials according to the protocol described in example 2.

1. A process for preparing an elastomeric composite material, comprising the successive steps:
(a) of introducing at least one oil and nanotubes, such as carbon nanotubes, into a compounding device and then kneading said at least one oil and said nanotubes, such as carbon nanotubes, in said compounding device, so as to obtain a masterbatch,
(b) of extruding said masterbatch,
(c) of diluting the masterbatch in an elastomeric matrix.

2. The process as claimed in claim 1, characterized in that the oil is chosen from:
plant oils containing at least 50% by weight of triglycerides consisting of fatty acid esters of glycerol;
synthetic oils of formula R1COOR2 in which R1 represents an aryl group or the residue of a linear or branched, higher fatty acid containing from 7 to 30 carbon atoms and R2 represents a branched or unbranched, optionally hydroxylated, hydrocarbon-based chain containing from 3 to 30 carbon atoms;
synthetic ethers;
linear or branched, saturated or unsaturated, C6 to C26 fatty alcohols;
silicone oils;
oils of mineral origin;
polymers containing linear or branched hydrocarbon-based monomers and/or aromatic hydrocarbon-based monomers;
cyclic hydrocarbons such as (alkyl)cycloalkanes and (alkyl)cycloalkenes, the alkyl chain of which is linear or branched, and saturated or unsaturated, having from 1 to 30 carbon atoms;
aromatic hydrocarbons;
fluoro oils, such as C8 to C24 perfluoroalkanes;
fluorosilicone oils;
and mixtures thereof.

3. The process as claimed in claim 2, characterized in that the oil is a mineral oil.

4. The process as claimed in any one of claims 1 to 3, characterized in that the nanotubes represent from 5% to 80% by weight, preferably from 10% to 50% by weight, and better still from 15% to 30% by weight, relative to the weight of the masterbatch.

5. The process as claimed in any one of the preceding claims, characterized in that, in step a), at least one additive that may be waxy or solid at atmospheric pressure and ambient temperature, such as a tackifying resin, is also introduced.

6. The process as claimed in any one of the preceding claims, characterized in that the kneading device is a co-rotating or counter-rotating twin-screw extruder or a co-kneader.

7. The process as claimed in any one of the preceding claims, characterized in that the elastomeric matrix contains an elastomeric resin base comprising one or more polymers chosen from: fluorocarbon or fluorosilicone elastomers; butadiene homopolymers and copolymers, optionally functionalized with unsaturated monomers such as maleic anhydride, (meth)acrylic acid, acrylonitrile (NBR) and/or styrene (SBR); neoprene (or polychloroprene); polyisoprene; copolymers of isoprene with styrene, butadiene, acrylonitrile and/or methyl methacrylate; copolymers based on propylene and/or ethylene and in particular terpolymers based on ethylene, propylene and dienes (EPDM), and also copolymers of these olefins with an alkyl (meth)acrylate or vinyl acetate; halogenated butyl rubbers; silicone elastomers such as poly(dimethylsiloxane)s with vinyl end groups; polyurethanes; polyesters; acrylic polymers such as poly(butyl acrylate) bearing carboxylic acid or epoxy functions; and also modified or functionalized derivatives thereof and mixtures thereof.

8. The process as claimed in claim 7, characterized in that the elastomeric resin base is chosen from olefin homopolymers and copolymers.

9. The process as claimed in any one of the preceding claims, characterized in that step (a) comprises the substeps consisting in:
1—bringing the oil into contact with the nanotubes without applying mechanical shear forces,
2—introducing the premix of nanotubes and oil into a compounding device and kneading said premix in said compounding device by applying mechanical shear forces, so as to obtain a masterbatch.

10. An elastomeric composite material that can be obtained according to the process as claimed in any one of the preceding claims.

11. The use of the composite material as claimed in claim 10 for the manufacture of bodywork or leakproofing seals, tires, sound-insulating plates, static charge dissipators, an inner conductive layer for high-voltage and medium-voltage cables, or anti-vibration systems such as motor vehicle shock absorbers, or in the manufacture of structural elements of bullet-proof vests.

12. The use, for conferring at least one electrical and/or mechanical and/or thermal property on an elastomeric matrix, of a masterbatch that can be obtained by kneading, in a compounding device, and then extruding, a polymer composition containing at least one oil and nanotubes, in particular carbon nanotubes, and optionally a tackifying resin.
